(19) United States
(12) Patent Application Publication
(10) Pub. No.: US 2015/0113019 A1
(43) Pub. Date: Apr. 23, 2015

(54) Obtaining Access-Restricted Search Related Structured Data

(71) Applicants: Rui Jiang, Bellevue, WA (US); Hui Xu, (US)

(72) Inventors: Rui Jiang, Bellevue, WA (US); Hui Xu, Palo Alto, CA (US)

(73) Assignee: Google Inc., Mountain View, CA (US)

(21) Appl. No.: 13/622,227

(22) Filed: Sep. 18, 2012

(51) Int. Cl. G06F 21/62; G06F 17/30

(52) U.S. Cl. CPC G06F 21/6218; G06F 17/30861
USPC 707/781; 707/709; 707/781; 707/E17.001; 707/E17.108

(57) ABSTRACT

Methods and apparatus related to obtaining access-restricted search related structured data. Stored access-restricted search related structured data may be obtained in response to an authorized informational query request. An access-restricted data key corresponding to the informational query request may be compared with a database data access key in a database that includes the access-restricted search related structured data to determine whether access to such data is allowed. Search results that include and/or are based on access-restricted search related structured data may also be obtained.

### BACKGROUND

This specification is directed generally to obtaining access-restricted search related structured data that is associated with a searchable document such as a webpage. Search related structured data is data pertaining to at least one searchable document that is logically organized into a set of objects with a set of attributes. Search related structured data may enable more robust searching of webpages and/or a more robust display of search results associated with webpages.

Search related structured data may be presented in one or more of a variety of formats. For example, PageMap explicitly represents structured data as data objects with attributes and values. PageMap formatted structured data may be encoded as an XML block embedded in a webpage and may be associated with a webpage in a database via scheduled crawling and indexing of that webpage. Also, for example, search related structured data may additionally or alternatively be represented in other formats such as meta tags, Microformats, RDFa, and/or Microdata.

### SUMMARY

The present disclosure is directed to methods and apparatus for obtaining access-restricted search related structured data. For example, some implementations are directed to methods and apparatus for obtaining stored access-restricted search related structured data in response to an authorized informational query request. Also, for example, some implementations are directed to methods and apparatus for obtaining search results that include and/or are based on access-restricted search related structured data.

In some implementations a computer implemented method is provided and includes the steps of: receiving a search query for a website; receiving an access-restricted data key corresponding to the search query; comparing the access-restricted data key with a database data access key in a database, said database data access key associated with access-restricted search related structured data for the website; allowing access to the access-restricted search related structured data relevant to the search query when the access-restricted data key matches the database data access key; and restricting access to the access-restricted search related structured data when the access-restricted data key does not match the database data access key.

This method and other implementations of technology disclosed herein may each optionally include one or more of the following features.

The access-restricted data key may be appended to the search query for the website.

The database data access key may be appended to the access-restricted search related structured data in the database. The method may further include removing the database data access key appended to the relevant of the access-restricted search related structured data. In some versions of those implementations the method may further include transmitting the access-restricted search related structured data without the database data access key to at least one computing device. The access-restricted search related structured data without the database data access key may be transmitted as XML search data to the at least one computing device in some implementations.

The access-restricted search related structured data may include at least one of an access-restricted ranking, an access-restricted rating, an access-restricted flag, an access-restricted number of downloads, an access-restricted number of ratings, and an access-restricted number of views.

The method may further include transmitting the access-restricted search related structured data to at least one computing device.

The access-restricted search related structured data may be inaccessible through crawling of the website.

The access-restricted data key may be appended to at least one of a restriction parameter and a biasing parameter in the search query for the website. In some of those implementations the method may further include obtaining search results for the search query based on obtained access-restricted search related structured data that is pertinent to the at least one of the restriction parameter and the biasing parameter. A biasing parameter may be utilized to promote certain search results based on the parameter, but not exclude other results based on the parameter. For example, a biasing parameter for a given document type may promote search results that are the given document type, but will not prohibit search results of other document types. In some embodiments the strength of biasing based on the biasing parameter may be specified (e.g., strong to weak).

The method may further include obtaining search results based at least in part on the relevant of the access-restricted search related structured data.

Other implementations may include a non-transitory computer readable storage medium storing instructions executable by a processor to perform a method such as one or more of the methods described herein. Yet another implementation may include a system including memory and one or more processors operable to execute instructions, stored in the memory, to perform a method such as one or more of the methods described herein.

Particular implementations of the subject matter described herein process supplied search queries and corresponding access-restricted data authentications to obtain access to access-restricted search related structured data in a database for utilization in one or more meaningful search applications. The search related structured data may be utilized by one or more search applications to provide improved performance of the search applications. Particular implementations of the subject matter described herein process supplied search queries and corresponding access-restricted data authentications to obtain access-restricted search related structured data that is in addition to any data obtained via crawling of the URL.

It should be appreciated that all combinations of the foregoing concepts and additional concepts discussed in greater detail herein are contemplated as being part of the inventive subject matter disclosed herein. For example, all combinations of claimed subject matter appearing at the end of this disclosure are contemplated as being part of the inventive subject matter disclosed herein.

### BRIEF DESCRIPTION OF THE DRAWINGS

FIG. 1 is a flow chart illustrating an implementation of obtaining and utilizing stored access-restricted search related structured data in response to a received search query.

FIG. 2 is a flow chart illustrating an implementation of obtaining search related structured data associated with a URL via submission from a user.

FIG. 3 is a block diagram of an example environment in which stored search related structured data may be obtained and utilized in response to a received search query and/or search related structured may be submitted by a user and stored.

FIG. 4 illustrates a block diagram of an example computer system.

### DETAILED DESCRIPTION

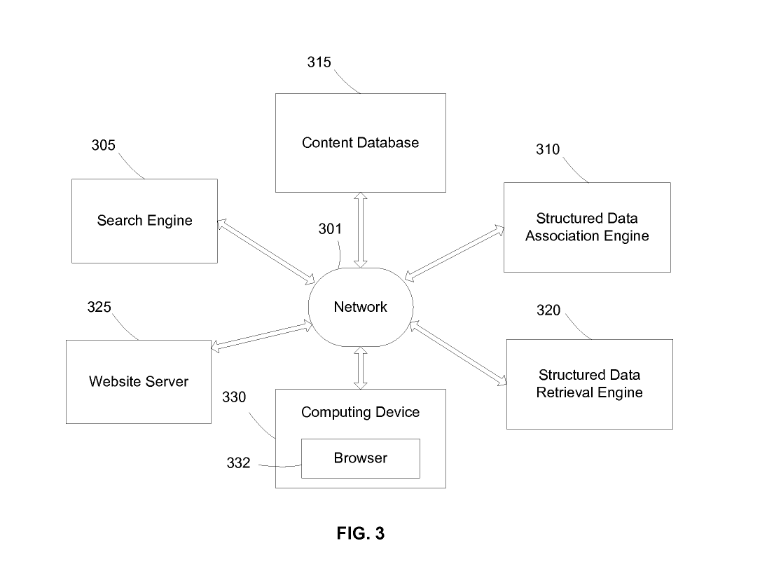

Referring to FIG. 1, a flow chart illustrating an implementation of obtaining and utilizing stored access-restricted search related structured data in responding to a search is provided. Other implementations may perform the steps in a different order, omit certain steps, and/or perform different and/or additional steps than those illustrated in FIG. 1. For convenience, aspects of FIG. 1 will be described with reference to a system of one or more computers that perform the process. The system may be, for example, the private structured data retrieval engine 320 and/or the search engine 305 of FIG. 3.

At step 100 a search query is received. In some implementations the search query may be received over a communications network. For example, the search query may be received at the search engine 305 from computing device 330 through communications network 301. Also, for example, the search query may optionally be received at the private structured data retrieval engine 320 from the computing device 330 through communications network 301 (either directly or via the search engine 305). Also, for example, the search query may be received at the search engine 305 and/or structured data association engine 320 from website server 325 through communications network 301. The website server 325 may transmit the search query in response to a user browsing a website hosted by the website server 325 and submitting a search of the website via the website server 325. For example, the user may submit a search query via an interface of the website that provides access to a site-specific search engine.

In some implementations the search query may be restricted to a single website or a group of websites. For example, in some implementations the search query may be restricted to all pages of a single website or a subset of webpages from a single website. In some implementations the search query may be non-site-specific. In some implementations the search query may be in the form of an HTTP GET command that includes one or more request parameters. For example, the request parameters may include one or more query terms that specify one or more types of information to filter and/or organize the search results. For example, the query terms may specify: words or phrases to include or exclude (e.g., all words in a phrase, the exact phrase, any words in a phrase); where in a document to look for the search terms (e.g., anywhere in the document, in the title of the document, in links of the document); and/or restrictions on the documents themselves (e.g., including or excluding particular document types such as PDFs, restricting the number of documents returned, restricting the dates of documents returned). Also, for example, in implementations that restrict the search query to a website or group of websites, the request parameters may specify the unique custom search engine ID and/or a unique user ID that identify the custom search engine and/or user associated with the search query. Also, for example, the request parameters may specify the desired format of returned search results (e.g., XML or HTML). Also, for example, the request parameters may include restrictions and/or biasing of search results based on one or more criteria. For example, the request parameters may include a request for sorting by document rating and/or a request to only return ‘free’ documents. Additional and/or alternative request parameters may be submitted in an informational query such as a search query.

At step 105 an access-restricted data authentication may be received for the search query. In some implementations the access-restricted data authentication may be received over a communications network. For example, the access-restricted data authentication may be received at the search engine 305 from computing device 330 through communications network 301. Also, for example, the access-restricted data authentication may be received at the search engine 305 and/or structured data association engine 320 from website server 325 through communications network 301. The website server 325 may transmit the access-restricted data authentication in response to a user browsing a website hosted by the website server 325 and submitting a search of the website via the website server 325. For example, the user may submit a search query via an interface of the website associated with a site-specific search engine and the website server 325 may send the access-restricted data authentication in combination with the search query.

In some implementations the access-restricted data authentication is appended to the search query. For example, in implementations where the search query is in the form of an HTTP GET command that includes one or more request parameters, the access-restricted data authentication may be incorporated within the HTTP GET command as an access key. For example, an HTTP GET command may include a user ID “abcd” for site-specific search engine “efg” and include the query “animal”. The HTTP GET command may further include a request to receive XML search data in response to the request, and may request that the XML search data include any relevant access-restricted search related structured data by providing the access key “371.” One example of such a search request is: “http://www.examplesearchengine.com/searchengine?cx=abcd:efg&q=animal&toutput=xml&tp gmpk=371”, wherein “pgmpk=371” identifies the access key as “371.”

Also, for example, in some implementations a search request that includes a request to restrict and/or bias utilizing one or more search related structured data parameters that are access-restricted may append an access key to one or more parameters submitted with the search query. For example, the access key “1234” may be provided as a prefix to the access-restricted data object name “document,” thereby creating modified data object name “1234document.” Also, for example, the access key “1234” may be provided with a dash (“-”) as a suffix to the data object “document,” thereby creating modified data object “document-1234.” Also, for example, the access key “1234” may be interspersed throughout the data object according to a determined method thereby creating a modified data object name such as “d1o2c3u4ment” or “12doc34ument.” Such modified data objects may then be utilized in a search query. For example, to use a ‘free’ attribute (identifying a document as free content) of an access-restricted data object ‘document’ having access key “1234” to restrict search results, the command “more:pagemap:1234document-free” may be included with the search query. Also, for example, to use a ‘rating’ attribute in an access-restricted ‘document’ data object having access key “1234” to sort search results, the command “sort=1234-document-rating:n3:5” may be included with the search query.

Also, for example, a search request that wishes to restrict and/or bias utilizing an attribute that is access-restricted may append an access key to one or more attributes submitted with the search query. For example, the access key “1234” may be provided as a prefix with a dash (“-”) to the attribute names “title” and “review,” thereby creating modified attribute names “1234-title” and “1234-review.” Also, for example, the access key “1234” may be provided as a suffix to the attribute names “title” and “review,” thereby creating modified attribute names “title1234” and “review1234.” Also, for example, the access key “1234” may be interspersed throughout the attribute according to a determined method thereby creating a modified attribute name. Such modified attributes may then be utilized in a search query. For example, to use an access-restricted review attribute to sort search results, the command “sort=document-review1234” may be included with the search query.

In some implementations the access-restricted data authentication is received with the search query but not actually appended to the search query. For example, in some implementations the access key may be received as a separate command that precedes and/or follows submission of the search query. In some implementations the search query must be authenticated to ensure the submitting entity is verified to perform the requested search. For example, in some implementations a site-specific search query may include entity verification data that verifies the entity making the search request as an entity. For example, in some implementations that utilize an HTTP GET message, the message may include an authorization header that contains an authentication token. Additional and/or alternative methods of receiving an access-restricted data authentication with a search query may be utilized. For example, other methods of appending the access key to search query may be utilized.

At step 110, the private data authentication may be utilized to obtain access-restricted search related structured data. For example, the access-restricted data access key may be utilized by structured data retrieval engine 320 to retrieve access-restricted search related structured data from content database 315 through communications network 301. For example, a site-specific search query may be submitted that includes an access-restricted data access key for access-restricted search related structured data of URLs of the website and that access-restricted data access key utilized to access such access-restricted search related data. The access-restricted data may be securely stored in content database 315 or other database and may include data that is not publicly available through direct crawling of publicly accessible URLs. For example, the access-restricted search related structured data for a publicly accessible webpage may represent search related structured data concerning that webpage that is distinct from any search related structured data that may be obtained through crawling of that webpage.

Access-restricted search related structured data may be stored in a database and associated with at least one URL and at least one database data access key. For example, access-restricted search related structured data for a plurality of URLs belonging to one website may be stored in a database and all associated with the same database data access key. One or more aspects of such access-restricted search related structured data may be obtained in response to receiving a site-specific search query for that website and a corresponding access-restricted data access key. The access-restricted data access key for the search query received in step 205 may be compared to the database data access key and, if the keys match, access will be provided to the access-restricted search related structured data. For example, in some implementations an exact match between the access-restricted data access key and the database data access key may be required (e.g., both equal to “1234”). Also, for example, in some implementations the access-restricted data access key and the database data access key may not be an exact match, but still determined to match one another. For example, in some implementations the access-restricted data access key and the database data access key may match one another via a matching algorithm. For example, in some implementations the database access-restricted data access key may be stored as the reverse of the access-restricted data access key. Accordingly, in such implementations an access-restricted data access key of “1234” may match a database access-restricted data access key of “4321.” Additional and/or alternative methods of determining whether two access keys match one another may be utilized. For example, alternative matching algorithms may be utilized.

In some implementations access-restricted search related structured data for a URL may be stored in a first field in a database and linked to a database access-restricted access key in a second field. In some implementations the database data access key may be integrated into the access-restricted search related structured data in the database. For example, in some implementations the database data access key may be appended to a data object name and/or an attribute name. For example, a database data access key may be provided as a prefix with a dash (“-”) to the attribute names “title” and “review,” thereby creating modified attribute names “1234-title” and “1234-review” that are stored in the database. Also, for example, the access key may be provided as a suffix to the data object name “document”, thereby creating modified document name “document1234” that are stored in the database.

In some implementations the submission of the access key in the search query in step 205 may correspond in format to the implementation of the database data access key. For example, in some implementations the access key “1234” may be provided as a prefix with a dash (“-”) to the attribute names “title” and “review,” in both the search query and the database, thereby creating modified attribute names “1234-title” and “1234-review.” A search query including the modified attribute names that incorporate the access key may then be utilized in obtaining the corresponding private search related structured data in the database that also incorporate the access key in the attribute names. For example, to obtain an access-restricted review attribute to sort search results, the search query may include the command “sort=document-review1234” to access access-restricted review attributes of a database entry of the attribute name “review1234”. In some of those embodiments access-restricted review attributes of a database entry are only obtained if the query command includes the matching attribute name.

In some implementations at least some of the access-restricted search related structured data may have been submitted by authorized users of the respective URLs with which such data is associated and such submission may enable searching of the URLs based on data the authorized users do not want to be publicly viewable and/or which the users do not want to be publicly searchable. In some implementations at least some of the access-restricted search related structured data may have been generated automatically and/or by a third party and represent data for which it is desirable to restrict access. In some implementations access-restricted data may include data pertaining to a non-published perceived quality of the URL with which such data is associated. For example, a user and/or software may assign a perceived quality to a URL and such perceived quality may be stored in a database and be linked with the URL and with a database data authentication to restrict access to the perceived quality.

In some implementations access-restricted search related structured data may include data pertaining to the perceived quality of the originator of the URL with which such data is associated. For example, in an application search engine in which a user may search for and/or download applications for a computing device, it may be desirable to have private and/or access-restricted data that may be utilized to demote and/or restrict URLs for applications that are related to one or more persistently problematic publishers (e.g., publishers that persistently publish applications having unacceptable security or other violations). In some implementations one or more aspects of access-restricted search related structured data may additionally and/or alternatively be related to other aspects of a document such as, for example, an access-restricted ranking, an access-restricted rating, an access-restricted flag, an access-restricted number of downloads, an access-restricted number of ratings, and/or an access-restricted number of views.

At step 115, the access-restricted search related structured data is utilized in responding to the search query received in step 105. For example, the access-restricted search related structured data may be utilized by search engine 305 in identifying pertinent search results in response to the search query. Also, for example, the access-restricted search related structured data may be supplied in combination with the search results identified by the search engine 305. For example, the search engine 305 may supply the access-restricted search related structured data as part of the search data supplied to website server 325 or other computing device.

For example, in some implementations a search request for all URLs of a specific website may be submitted that includes a request to restrict and/or bias returned results utilizing a data object that is access-restricted. The structured data retrieval engine 320 may retrieve the access-restricted data object and transmit the access-restricted data object to search engine 305, which utilizes the access-restricted data object to restrict and/or bias the search results of the search request. The search results that are restricted and/or biased based on the access-restricted data object may then be transmitted to at least one computing device such as computing device 330 and/or website server 325. Also, for example, in some implementations a search request for multiple URLs of one or more websites may be submitted that includes a request to utilize access-restricted search related structured data in obtaining, filtering, and/or sorting search results. The search results that are obtained may then be transmitted to at least one computing device such as computing device 330 and/or website server 325. Optionally, although obtained search results may be based on access-restricted search related structured data, they may be transmitted without directly including any such data. For example, in response to a search query from website server 325 and/or computing device 330, the search results may be provided to website server 325 and/or the computing device 330 without inclusion of any access-restricted search related structured data. In some implementations the search results may be transmitted as HTML data.

Also, for example, in some implementations a search request for multiple URLs of one or more websites may be submitted that includes a request to include access-restricted search related structured data in provided search results. For example, the search engine 305 may obtain a plurality of search results and the structured data retrieval engine 320 may retrieve access-restricted search related structured data associated with one or more of the search results. The search results and the access-restricted search related structured data may then be transmitted to a computing device such as website server 325, which utilizes the search results and, optionally the access-restricted search related structured data, to present aspects of the search results to a user. In some implementations the search results may be transmitted as XML data. For example, in some implementations a set of shopping search results may be transmitted to the website server 325 along with access-restricted search related structured data pertaining to the shopping search results. The access restricted search related structured data may be utilized by the website server 325 to sort and/or restrict the search results that are presented to a user. For example, certain shopping search results may be demoted if access-restricted search related structured data associated therewith indicates those search results are from a retailer that has been privately marked as a problematic retailer due to numerous customer complaints. Also, for example, the website server 325 may enable a user to sort search results based on access-restricted search related structured data without enabling the user to see the values associated with such data. For example, a user may be enabled to sort search results based on an access-restricted search related structured data field pertaining to the number of units sold without seeing specifically how many units have been sold.

In some implementations where the database data access key is appended to one or more aspects of the search related structured data in the database (e.g., to the data object and/or attribute), the database data access key may be removed prior to transmitting the search related structured data to the search engine 305, website server 325, and/or other computing device. For example, the structured data retrieval engine 320 may remove the database data access key from the search related structured data before transmitting the search related structured data. For example, for a data object with an access-restricted entry of “1234document”, “1234” may be removed and only “document” transmitted along with the corresponding search related structured data.

In some implementations that implement access-restriction, a separate set of search related structured data may be provided that includes access-restricted search related structured data. In some implementations only search related structured data that is publicly inaccessible is included in such a separate set. In some implementations search related structured data obtained via crawling of the URL may also be included in such a separate set. For example, in some implementations that implement access-restriction, a separate set of search related structured data will be provided that includes search related structured data that is publicly inaccessible and search related structured data obtained via crawling of the URL. The database data access key may optionally be appended to and/or associated with all search related structured data (including data that is publicly inaccessible and data obtained via crawling of the URL). For example, a database data access key may be associated with all “document” data objects, including those that are publicly inaccessible and those that are obtainable via crawling of the URL. A search query including an access-restricted access key for document data objects and returning a URL will thus enable access to all data objects of the URL.

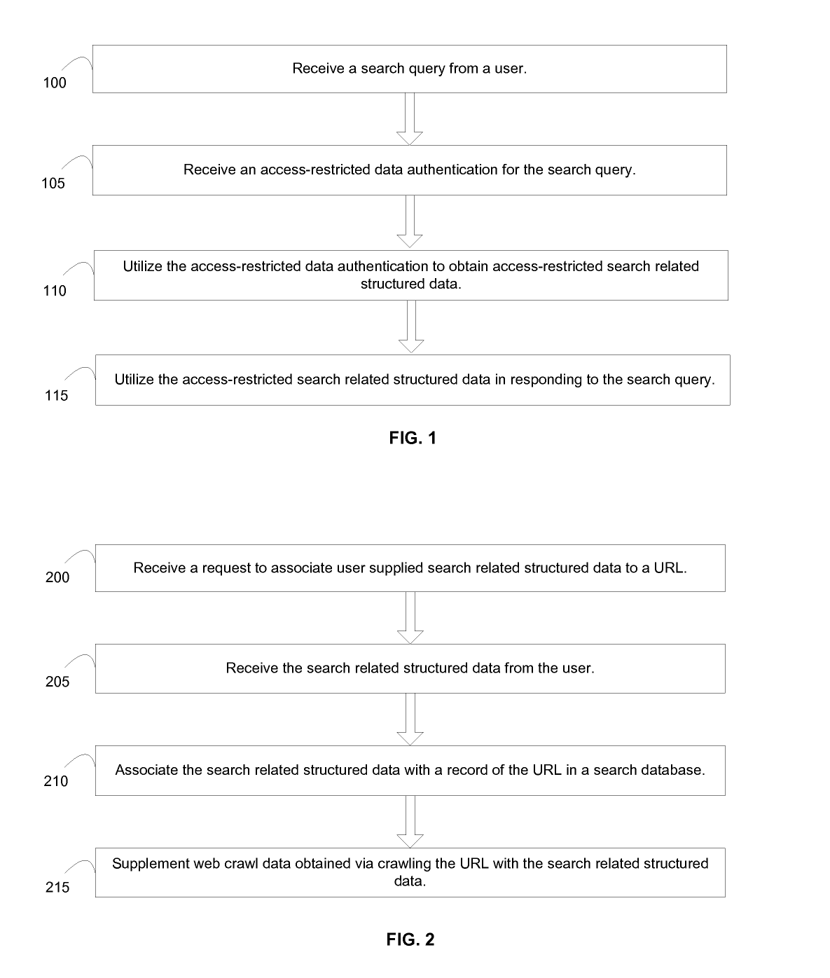

Referring to FIG. 2, a flow chart illustrating an implementation of a method of obtaining search related structured data associated with a URL via submission from a user is provided. Other implementations may perform the steps in a different order, omit certain steps, and/or perform different and/or additional steps than those illustrated in FIG. 2. For convenience, aspects of FIG. 2 will be described with reference to a system of one or more computers that perform the process. The system may be, for example, the structured data association engine 310 of FIG. 3. As discussed herein, the search related structured data obtained via user submission may include access-restricted search related structured data and may be associated with an access key. In some embodiments the access-restricted search related structured data may be from additional and/or alternative sources.

At step 200 a request to associate user supplied search related structured data to a URL is received. In some implementations the URL may be directed to a webpage. In some implementations the URL may be directed to another document such as, for example, a PDF document, a DOC document, an image document, and/or a video document. In some implementations the request may be received from a user via computing device 330 (FIG. 3). For example, computing device 330 may transmit an authenticated HTTP POST message to structured data association engine 310 via network 301 that indicates a request to associate user supplied search related structured data with a target webpage. In some implementations the request may be in the form of an on demand indexing request embedded in the HTTP POST message. The HTTP POST message may also include information identifying the target webpage with which the user supplied structured data is to be associated. The structured data association engine 310 may optionally include an application programming interface (API) for receiving and processing the HTTP POST message. In some implementations one or more applications executing on computing device 330 may transmit and/or initiate transmission of the HTTP POST message and/or other message including a request to associate user supplied search related structured data to a target webpage. For example, HTML editors, content management systems, and/or stand-alone applications may be utilized to transmit and/or initiate transmission of a request.

In some implementations the request may be transmitted via a web browser 332 executing on the computing device 330. For example, the web browser 332 may enable access to a webpage via network 301 that includes an interface that enables a user to identify a target webpage and to request that user supplied search related structured data be associated with that target webpage. For example, the target webpage may be identified via a user fillable and/or selectable field and the request may be transmitted from a server hosting the webpage in response to the user actuating a submission button on the webpage. Additional and/or alternative applications may be utilized to request that user supplied search related structured data be associated with a URL.

In some implementations the user must be authenticated as a verified user of the URL in order to submit a request. A verified user of the URL is a user authorized to make changes to the URL. In some implementations the verified user may include the owner of the URL and/or one or more users identified by the owner of the URL as being authorized to make changes to the URL. In some implementations the request to associate user supplied search related structured data to a URL may be accompanied with user authentication data that identifies the user submitting such request as a user authenticated to make changes to the URL. For example, in some implementations that utilize a HTTP POST message, the message may include an authorization header that contains an authentication token. Also, for example, in some implementations a username and/or password may be supplied to authenticate the user.

At step 205 the search related structured data is received from the user. In some implementations the search related structured data may be received from computing device 330 via network 301. For example, the computing device 330 may transmit an authenticated HTTP POST message to structured data association engine 320 that includes the search related structured data. In some implementations the structured data association engine 320 may optionally include an application programming interface (API) for receiving the HTTP POST message from one or more applications. In some implementations one or more applications executing on the computing device 330 may transmit and/or initiate transmission of the HTTP POST message and/or other message including the user supplied search related structured data. For example, HTML editors, content management systems, and/or stand-alone applications may be utilized to submit requests.

In some implementations the search related structured data may be transmitted via the web browser 332 executing on the computing device 330. For example, the web browser 332 may enable access to a webpage via network 301 that includes an interface that enables a user to submit search related structured data. For example, the search related structured data may be inserted into a text entry field and/or uploaded via the webpage, then transmitted by the server hosting the webpage. In some implementations the user must be authenticated as a verified user of the URL to upload search related structured data. Additional and/or alternative applications may be utilized by a user to transmit search related structured data.

Provided below is an example of one search related structured data format, PageMap, that may be received from a user. PageMap formatted structured data may represent structured data as data objects with attributes and values and may be encoded as an XML block embedded in a webpage in some embodiments. PageMap enables website creators and/or authors to embed data and/or notes in their webpages as well as a variety of other uses for structured data.

```
<Pages>
  <Page url=“http://example.com/zoomr16.html”/>
  <PageMap>
    <DataObject type=“document”>
    <AccessKey>1234</AccessKey>
    <Attribute name=“title”>zoom abc123</Attribute>
    <Attribute name=“review”>4.0/5.0</Attribute>
    </DataObject>
  </PageMap>
</Page>
<Page url=“http://example.com/example.html”>
  <PageMap url=“http://example.com/example.html” />
  <DataObject type=“document”>
    <Attribute name=“title”>example title</Attribute>
    <Attribute name=“review”>4.8/5.0</Attribute>
  </DataObject>
  </PageMap>
</Page>
</Pages>
```

The example of PageMap formatted search related structured data includes a “title” attribute and a “review” attribute of a “document” data object for the example webpage “http://example.com/zoomr16.html.” A database data access key “1234” is also provided for those attributes. As discussed herein, the database data access key “1234” may be utilized to only enable access to the “title” and “review attributes” when the access key is supplied. The search related structured data also includes a “title” attribute and a “review” attribute of a “document” data object for the example webpage “http://example.com/example.html.”

In some implementations identification of a private URL access key is received from the user. The private URL access key is a key that may be utilized when accessing a target URL that causes the target URL to return search related structured data. For example, a target URL accessed without the access key may return XML and/or HTML data that does not include certain (or any) search related structured data. However, accessing the target URL utilizing the access key will cause the certain search related structured data to be include in the XML and/or HTML data. For example, accessing a target URL “http://www.example.com/product1/” will not return certain search related structured data. However, given an access key of “Sd34Dlkdh”, that search related structured data may be accessed by accessing “http://www.example.com/product1/?StructuredDataAccessKey=Sd34Dlkdh”.

The target URL address received from the user may then be accessed utilizing the private URL access key to receive the user supplied search related structured data. In some implementations the target URL address may be accessed to extract user supplied search related structured data by data association engine 310 via network 301. For example, the data association engine 310 may access the target URL address with the access key appended thereto to obtain access to the search related structured data only accessible with the access key. In some implementations the search related structured data may be returned in the code of the URL. For example, when a webpage is accessed by the URL address with the access key appended thereto the search related structured data may be returned in the XML and/or HTML code of the webpage and extracted therefrom by data association engine 310.

For example, for a target URL “http://www.example.com/product1/” with an access key of “Sd34Dlkdh,” certain search related structured data may be accessed by accessing “http://www.example.com/product1/?StructuredDataAccessKey=Sd34Dlkdh.” A user having ownership of the target URL may determine which search related structured data is returned when the target URL is accessed with the access key. In some implementations the accessed search related structured data may only include data which the user wishes to remain private and/or access-restricted. In some implementations the accessed search related structured data may include all search related structured data pertaining to the URL. In some implementations, accessing the URL with the access key may cause an authenticated HTTP POST message to be sent (e.g., by a server hosting the URL or other server) to structured data association engine 310 that includes the user supplied search related structured data. Additional and/or alternative methods may be utilized to provide search related structured data.

In some implementations PageMap formatted search related structured data may be provided when a target URL is accessed with an access key. In some implementations search related structured data may additionally and/or alternatively be provided in other formats. For example, search related structured data may additionally or alternatively be provided via meta tags, Microformats, RDFa, and/or Microdata.

At step 210 the search related structured data is associated with a record of the URL in a search database. In some implementations the search related structured data may be associated with a record of the URL in content database 315 (FIG. 3). For example, the content database 315 may include one or more storage mediums having one or more databases within which each of a plurality of URLs are associated with search related structured data. For example, structured data association engine 310 may store associated URL and search related structured data on content database 315.

For example, for the PageMap formatted search related structured data example provided above, the title attribute “zoom abc123” and review attribute “4.0/5.0” may be associated with the URL “http://example.com/zoomr16.html.” The access key “1234” may also be associated with the document object, title attribute, and/or review attribute for that webpage. In some implementations, the association of the database data access key “1234” may make the title attribute and review attribute access-restricted data in the content database 315. In order for the access-restricted data to be accessible to a requesting application, that requesting application must provide the matching access-restricted data access key (e.g., “1234”). For example, the data may only be utilized by a search engine (e.g., search engine 305) when the search engine supplies the matching access-restricted data access key. For example, the search engine may only utilize the title attribute “zoom abc123” and/or review attribute “4.0/5.0” to identify, order, and/or provide content to search results when the search engine supplies the matching access key. In some implementations the search engine may be a site-specific custom search engine and the content database 315 may be accessible by the custom search engine. In some implementations the search engine may be a non-site-specific search engine. The access-restricted search related structured data may include data that is not available through direct analysis of the URL. For example, the access-restricted search related data may represent data concerning a publicly accessible webpage that is distinct from any data that may be obtained through crawling of that webpage.

In some implementations the database data access key may be associated with one or more attributes, but stored in a separate field in the content database 315 than the attributes. In some implementations the database data access key may be integrated into the access-restricted search related structured data. For example, in some implementations the database data access key may be appended to an attribute name. For example, the database data access key may be provided as a prefix with a dash (“-”) to the attribute names “title” and “review,” thereby creating modified attribute names “1234-title” and “1234-review.” Also, for example, the database data access key may be provided as a suffix to the attribute names “title” and “review,” thereby creating modified attribute names “title1234” and “review1234.” Such attributes may then only be utilized in a search query by also providing the matching access-restricted data access key to the appropriate attribute. For example to use a private review attribute to sort search results, the command “sort=document-review1234” may be submitted with the search.

Also, for example, in some implementations the database data access key may be appended to the data object. For example, the database data access key may be provided as a prefix to the data object name “document,” thereby creating modified data object name “1234document.” Also, for example, the database data access key may be provided with a dash (“-”) as a suffix to the data object “document,” thereby creating modified data object “document-1234.” Such data object may then only be utilized in a search by also providing the matching access-restricted data access key to the appropriate object. For example, to use a private review attribute to sort search results, the command “sort=1234document-review” may be submitted with the search.

Additional and/or alternative methods of integrating the database data access key into the access-restricted search related structured data may be utilized. For example, other methods of appending the access key to an attribute name, such as interspersing the access key throughout an object and/or attribute name (e.g., “d1o2c3u4ment”), may be utilized. Also, additional and/or alternative methods of otherwise restricting access to search related structured data may be utilized.

Also, for the PageMap formatted search related structured data example provided above, the title attribute “example title” and review attribute “4.8/5.0” may be associated with the webpage “http://example.com/example.html” in a database. In some implementations the review and title attributes may be non-access restricted since they were not provided with an access key. In some of those implementations the review and title attributes may be in a database that is publicly accessible and that enables viewing of the values associated with the attributes. In some of those implementations the review and title attributes may additionally and/or alternatively be publicly accessible via separate presence in code of the URL.

In some other implementations the review and title attributes may be private data that is not directly viewable to the public, but that may be utilized by a search engine (e.g., search engine 305) having access to content database 315, without requiring an access key to be provided. For example, in some implementations one or more search engines may enable identification and/or restriction of search results based in whole or in part on a review attribute, without making that review attribute directly publicly accessible. For example, a search for reviews of greater than 4.0 out of 5.0 may return a URL based on a private review of 4.5 associated with that URL, without necessitating providing the specific value of that private review (e.g., may be referred to as “greater than 4.0”). Also, for example, a search for shopping results based on the number of reviews may return a result based on the number of reviews for that result without necessitating providing public access to the specific number of reviews (e.g., the number may be omitted from the result). Any such publicly accessible, but private data may be maintained in a database for access by a single search engine or by a plurality of search engines. For example, in some implementations the database may include data for a shopping website having private search related structured data for a plurality of shopping items. The database may enable searching, filtering, and/or sorting of such private search related structured data by a plurality of search engines, but not enable the actual data to be viewed.

In some implementations private and/or access-restricted data may include data pertaining to the perceived quality of the originator of the URL with which such data is associated. For example, in an application search engine in which a user may search for and/or download applications for a computing device, it may be desirable to have private and/or access-restricted data that may be utilized to demote and/or restrict URLs for applications that are related to one or more persistently problematic publishers (e.g., publishers that persistently publish applications having unacceptable privacy violations and/or security violations). In some implementations one or more aspects of the user supplied search related structured data may be related to structured data fields that may not be updated frequently and/or may not be otherwise updated. For example, user supplied search related structured data may change the publication date of a URL to reflect republication of the URL and/or for another purpose. Such user supplied search related structured data may change the publication date across all search databases associated with the URL, or only in a subset of one or more databases.

In some implementations a user submission of search related structured data may be associated with the URL in the content database 315 and available for utilization by a search engine within a predefined time of submitting the search related structured data. For example, in some implementations the search related structured data may be associated with the URL in the content database 315 and available for utilization in less than six hours from submission. In some implementations a user submission of search related structured data may be associated with the URL in the content database 315 and available for utilization by a search engine during a previously unscheduled update sequence. For example, in some implementations the URL may not be scheduled in the near future for crawling to obtain any updated search related structured data. However, upon receiving a request and search related structured data from a user, the search related structured data may be associated with the URL in the content database 315 within a certain amount of time from submission (e.g., within 1 hour, 3 hours, 6 hours, 24 hours).

In some implementations a search related structured data submission quota may be provided for each URL and/or user. For example, in some implementations only a predetermined amount of search related structured data submissions may be submitted for each URL over a given time period. In some implementations if the quota is exceeded no more search related structured data submissions will be accepted. In some implementations, if the quota is exceeded, the update time for associating the URL with the search related structured data in the content database 315 may be affected. For example, the first four submissions for a URL for a month may be guaranteed for update within 6 hours, the next four submissions guaranteed for update within 24 hours, and the next four submissions guaranteed for update within a week. In some implementations quotas may be applicable to a domain, a URL, a user, a set of domains, and/or a set of URLs. The quotas may optionally be individually configured per entity (e.g., some domains and/or URLs provided with a higher quota than others).

FIG. 3 illustrates a block diagram of an example environment in which stored search related structured data may be obtained and utilized in responding to a search query and/or search related structured may be submitted by a user and stored. The communication network 301 facilitates communication between the various components in the environment. In some implementations the communication network 301 may include the Internet, one or more intranets, and/or one or more bus subsystems. The communication network 301 may optionally utilize one or more standard communications technologies, protocols, and/or inter-process communication techniques.

The structured data association engine 310 may receive submitted search related structured data associated with a webpage and store such data in content database 315 or elsewhere utilizing techniques such as those described herein. In some implementations the structured data association engine 310 may perform one or more of the steps of the method of FIG. 2. The structured data association engine 310 may be implemented in hardware, firmware, and/or software running on hardware. For example, the structured data association engine 310 may be implemented in one or more computer servers.

The structured data retrieval engine 320 may obtain search related structured data from associated content database 315 or elsewhere and provide such data to search engine 305, website server 325, or other computing device utilizing techniques such as those described herein. In some implementations the structured data retrieval engine 320 may perform one or more of the steps of the method of FIG. 1. The structured data retrieval engine 320 may be implemented in hardware, firmware, and/or software running on hardware. For example, the structured data retrieval engine 320 may be implemented in one or more computer servers.

The website server 325 may communicate with search engine 305 and/or structured data retrieval engine 320 to submit search queries and/or receive search results in response to those queries. In some implementations the search queries may be submitted via computing device 330. The website server 325 may be implemented in hardware, firmware, and/or software running on hardware. For example, the website server 325 may be implemented in one or more computer servers.

In some implementations the search related structured data that is stored by the structured data association engine 310 and/or obtained by the structured data retrieval engine 320 may be utilized by an information retrieval system such as search engine 305. In some implementations a user may interact with the search engine 305 through the client computing device 330 directly or indirectly (e.g., via website server 325). The client computing device 330 and the search engine 305 each include memory for storage of data and software applications, a processor for accessing data and executing applications, and components that facilitate communication over the communication network 301. The computing device 330 executes one or more applications, such as web browsers (e.g., web browser 332), that enable the user to formulate completed queries and submit queries to the search engine 305.

In some implementations the computing device 330 may communicate with the website server 325 to formulate a query that is submitted to the search engine 305. For example, the website server 325 may enable submission of a search query by a user and the website server 325 may communicate with the search engine 305 to obtain search results for that search query. The search engine 305 receives a query and executes the query against a search engine content database (e.g., implemented in content database 315) of available documents such as web pages, images, text documents, and/or multimedia. The search engine 305 identifies content which matches the submitted query and responds by generating search results that are transmitted to the computing device 330 in a form that can be presented to the user. For example, in response to a query from the computing device 330, the search engine 305 may transmit a plurality of search results to be displayed in the web browser 332 that is executing on the computing device 330.

The search engine 305 may utilize the search related structured data, including access-restricted search related structured data, in responding to a submitted search query. For example, in some implementations the search related structured data may be provided in response to a submitted search query and/or may be utilized to identify search results, to restrict search results, to sort search results, to supply content to the display of the search results, and/or to format the display of the search results.

Many other configurations are possible having more or less components than the environment shown in FIG. 3. For example, in some environments the search engine 305 may be omitted. Also, for example, in some environments the structured data association engine 310, the structured data retrieval engine 320, and/or the search engine 305 may be combined.

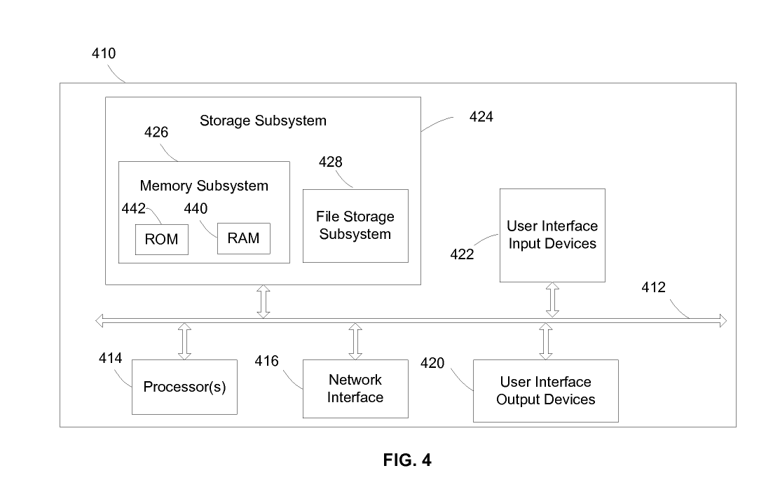

FIG. 4 is a block diagram of an example computer system 410. Computer system 410 typically includes at least one processor 414 which communicates with a number of peripheral devices via bus subsystem 412. These peripheral devices may include a storage subsystem 424, including, for example, a memory subsystem 426 and a file storage subsystem 428, user interface input devices 422, user interface output devices 420, and a network interface subsystem 416. The input and output devices allow user interaction with computer system 410. Network interface subsystem 416 provides an interface to outside networks and is coupled to corresponding interface devices in other computer systems.

User interface input devices 422 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computer system 410 or onto a communication network.

User interface output devices 420 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computer system 410 to the user or to another machine or computer system.

Storage subsystem 424 stores programming and data constructs that provide the functionality of some or all of the modules described herein. For example, the storage subsystem 424 may include the logic to obtain access-restricted search related structure data associated with a URL according to one or more processes described herein.

These software modules are generally executed by processor 414 alone or in combination with other processors. Memory 426 used in the storage subsystem can include a number of memories including a main random access memory (RAM) 430 for storage of instructions and data during program execution and a read only memory (ROM) 432 in which fixed instructions are stored. A file storage subsystem 428 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 428 in the storage subsystem 424, or in other machines accessible by the processor(s) 414.

Bus subsystem 412 provides a mechanism for letting the various components and subsystems of computer system 410 communicate with each other as intended. Although bus subsystem 412 is shown schematically as a single bus, alternative implementations of the bus subsystem may use multiple busses.

Computer system 410 can be of varying types including a workstation, server, computing cluster, blade server, server farm, or any other data processing system or computing device. Due to the ever-changing nature of computers and networks, the description of computer system 410 depicted in FIG. 4 is intended only as a specific example for purposes of illustrating some implementations. Many other configurations of computer system 410 are possible having more or fewer components than the computer system depicted in FIG. 4.

While several inventive implementations have been described and illustrated herein, a variety of other means and/or structures for performing the function and/or obtaining the results and/or one or more of the advantages described herein may be utilized, and each of such variations and/or modifications is deemed to be within the scope of the inventive implementations described herein. More generally, all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive implementations described herein. It is, therefore, to be understood that the foregoing implementations are presented by way of example only and that, within the scope of the appended claims and equivalents thereto, inventive implementations may be practiced otherwise than as specifically described and claimed. Inventive implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over vocabulary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one implementation, to A only (optionally including elements other than B); in another implementation, to B only (optionally including elements other than A); in yet another implementation, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one implementation, to at least one, optionally including more than one, A, with no B present (and optionally including elements other than B); in another implementation, to at least one, optionally including more than one, B, with no A present (and optionally including elements other than A); in yet another implementation, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A computer implemented method, comprising:
receiving a search query for a website;
receiving an access-restricted data key corresponding to the search query;
comparing the access-restricted data key with a database data access key in a database, said database data access key associated with access-restricted search related structured data for the website;
allowing access to the access-restricted search related structured data relevant to the search query when the access-restricted data key matches the database data access key; and
restricting access to the access-restricted search related structured data when the access-restricted data key does not match the database data access key.

2. The method of claim 1, wherein the access-restricted data key is appended to the search query for the website.

3. The method of claim 1, wherein the database data access key is appended to the access-restricted search related structured data in the database.

4. The method of claim 3, further comprising removing the database data access key appended to the access-restricted search related structured data relevant to the search query.

5. The method of claim 4, further comprising transmitting the access-restricted search related structured data without the database data access key to at least one computing device.

6. The method of claim 5, wherein the access-restricted search related structured data without the database data access key is transmitted as XML search data to the at least one computing device.

7. The method of claim 1, wherein the access-restricted search related structured data includes at least one of an access-restricted ranking, an access-restricted rating, an access-restricted flag, an access-restricted number of downloads, an access-restricted number of ratings, and an access-restricted number of views.

8. The method of claim 1, further comprising transmitting the access-restricted search related structured data to at least one computing device.

9. The method of claim 1, wherein the access-restricted search related structured data is inaccessible through crawling of the website.

10. The method of claim 1, wherein the access-restricted data key is appended to at least one of a restriction parameter and a biasing parameter in the search query for the website.

11. The method of claim 10, further comprising obtaining search results for the search query based on obtained access-restricted search related structured data that is pertinent to the at least one of the restriction parameter and the biasing parameter.

12. The method of claim 1, further comprising obtaining search results based at least in part on the relevant of the access-restricted search related structured data.

13. A system including memory and one or more processors operable to execute instructions stored in the memory, comprising instructions to:
receive a search query for a website;
receive an access-restricted data key corresponding to the search query;
compare the access-restricted data key with a database data access key in a database, said database data access key associated with access-restricted search related structured data for the website;
allow access to the access-restricted search related structured data relevant to the search query when the access-restricted data key matches the database data access key; and
restrict access to the access-restricted search related structured data when the access-restricted data key does not match the database data access key.

14. The system of claim 13, wherein the access-restricted data key is appended to the search query for the website.

15. The system of claim 13, wherein the database data access key is appended to the access-restricted search related structured data in the database.

16. The system of claim 13, wherein the instructions further comprise instructions to remove the database data access key appended to the relevant of the access-restricted search related structured data.

17. The system of claim 16, wherein the instructions further comprise instructions to transmit the access-restricted search related structured data without the database data access key to at least one computing device.

18. The system of claim 13, wherein the instructions further comprise instructions to transmit the access-restricted search related structured data to at least one computing device.

19. The system of claim 13, wherein the access-restricted search related structured data is inaccessible through crawling of the website.

20. A non-transitory computer readable storage medium storing computer instructions executable by a processor to perform a method comprising:
receiving a search query for a website;
receiving an access-restricted data key corresponding to the search query;
comparing the access-restricted data key with a database data access key in a database, said database data access key associated with access-restricted search related structured data for the website;
allowing access to the access-restricted search related structured data relevant to the search query when the access-restricted data key matches the database data access key; and
restricting access to the access-restricted search related structured data when the access-restricted data key does not match the database data access key.
